(19) United States
(12) Patent Application Publication
(10) Pub. No.: US 2026/0223133 A1
(43) Pub. Date: Jul. 30, 2026

(54) SYSTEM INFORMATION BLOCK 1 (SIB1) REPETITION

(71) Applicant: Samsung Electronics Co., Ltd., Suwon-si (KR)

(72) Inventor: Hongbo Si, Allen, TX (US)

(21) Appl. No.: 19/450,651

(22) Filed: Jan. 15, 2026

Related U.S. Application Data
(60) Provisional application No. 63/751,087, filed on Jan. 29, 2025.

(51) Int. Cl. H04W 72/232

(52) U.S. Cl. CPC H04W 72/232

(57) ABSTRACT

Apparatuses and methods for system information block 1 (SIB1) repetition. A method performed by a user equipment includes receiving a synchronization signals and physical broadcast channel (SS/PBCH) block in a cell and identifying, based on a physical broadcast channel (PBCH) in the SS/PBCH block, an indication associated with a repetition of a physical downlink control channel (PDCCH). The method further includes determining, based on the indication, that a PDCCH carrying a downlink control information (DCI) format is to be monitored in a first slot (n₀) and a second slot (n₀+1), determining that the DCI format carried in a first PDCCH in the first slot and a second PDCCH in the second slot is the same, and receiving the first PDCCH and the second PDCCH.

### CROSS-REFERENCE TO RELATED AND CLAIM OF PRIORITY

The present application claims priority under 35 U.S.C. § 119(e) to U.S. Provisional Patent Application No. 63/751,087 filed on Jan. 29, 2025, which is hereby incorporated by reference in its entirety.

### TECHNICAL FIELD

The present disclosure relates generally to wireless communication systems and, more specifically, the present disclosure is related to a method and apparatus of SIB1 repetition.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus of SIB1 repetition.

In one embodiment, a user equipment (UE) is provided. The UE includes user equipment (UE) in a wireless communication system is provided. The UE includes a transceiver configured to receive a synchronization signals and physical broadcast channel (SS/PBCH) block in a cell and a processor operably coupled to the transceiver. The processor is configured to identify, based on a physical broadcast channel (PBCH) in the SS/PBCH block, an indication associated with a repetition of a physical downlink control channel (PDCCH); determine, based on the indication, that a PDCCH carrying a downlink control information (DCI) format is to be monitored in a first slot (n₀) and a second slot (n₀+1); and determine that the DCI format carried in a first PDCCH in the first slot and a second PDCCH in the second slot is the same. The transceiver is further configured to receive the first PDCCH and the second PDCCH.

In another embodiment, a base station (BS) is provided. The BS includes a base station (BS) in a wireless communication system is provided. The BS includes a processor configured to determine, based on a PBCH in a SS/PBCH block in a cell, an indication associated with a repetition of a PDCCH, determine, based on the indication, that a PDCCH carrying a DCI format is to be transmitted in a first slot (n₀) and a second slot (n₀+1), and determine that the DCI format carried in a first PDCCH in the first slot and a second PDCCH in the second slot is the same. The BS further includes a transceiver operably coupled to the processor. The transceiver is configured to transmit the SS/PBCH block and transmit the first PDCCH and the second PDCCH.

In yet another embodiment, a method performed by a user equipment is provided. The method includes a method of a UE in a wireless communication system is provided. The method includes receiving a SS/PBCH block in a cell and identifying, based on a PBCH in the SS/PBCH block, an indication associated with a repetition of a PDCCH. The method further includes determining, based on the indication, that a PDCCH carrying a downlink control information (DCI) format is to be monitored in a first slot (n₀) and a second slot (n₀+1), determining that the DCI format carried in a first PDCCH in the first slot and a second PDCCH in the second slot is the same, and receiving the first PDCCH and the second PDCCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIGS. 5-7 illustrate example repetition patterns of SIB1 that each relate to burst level repetition according to embodiments of the present disclosure;

FIGS. 8 and 9 illustrate example repetition patterns of SIB1 that each relate to block level repetition according to embodiments of the present disclosure;

FIG. 10 illustrates an example method performed by a UE in a wireless communication system according to embodiments of the present disclosure; and

FIG. 11 illustrates another example method performed by a UE in a wireless communication system according to embodiments of the present disclosure.

### DETAILED DESCRIPTION

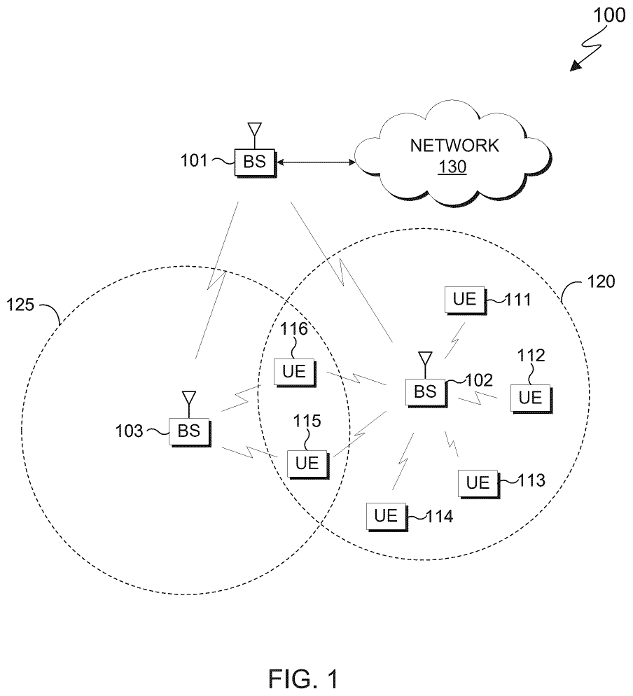

FIGS. 1-11 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v18.1.0, “NR; Physical channels and modulation” (herein, “REF 1”); 3GPP TS 38.212 v18.1.0, “NR; Multiplexing and channel coding” (herein, “REF 2”); 3GPP TS 38.213 v18.1.0, “NR; Physical layer procedures for control” (herein, “REF 3”); 3GPP TS 38.214 v18.1.0, “NR; Physical layer procedures for data” (herein, “REF 4”); and 3GPP TS 38.331 v18.1.0, “NR; Radio Resource Control (RRC) protocol specification” (herein, “REF 5”).

FIGS. 1-3 below describe various embodiments implemented in wireless communications systems and with the use of orthogonal frequency division multiplexing (OFDM) or orthogonal frequency division multiple access (OFDMA) communication techniques. However, this disclosure can be extended to other OFDM-based transmission waveforms or multiple access schemes such as filtered OFDM (F-OFDM). The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing SIB1 repetition. In certain embodiments, one or more of the gNBs 101-103 include circuitry, programing, or a combination thereof to support SIB1 repetition.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

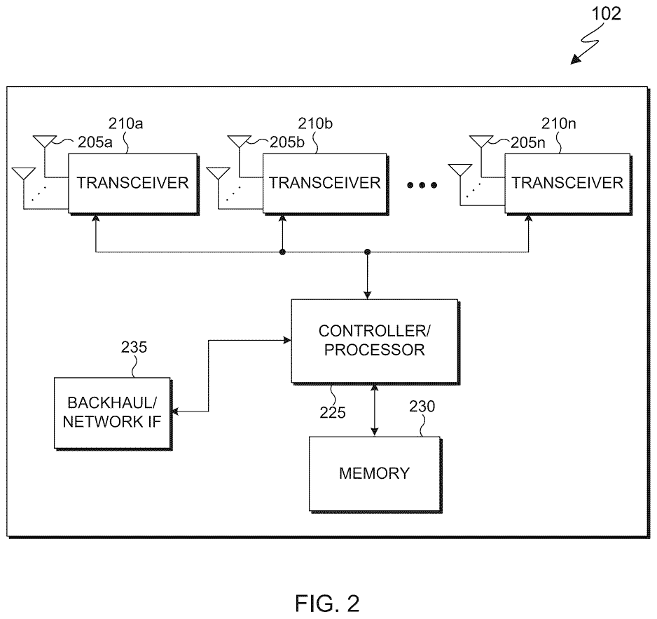

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting SIB1 repetition. Any of a wide variety of other functions could be supported in the gNB 102 by the controller/processor 225.

The controller/processor 225 is also capable of executing programs and other processes resident in the memory 230, such as processes to support SIB1 repetition. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

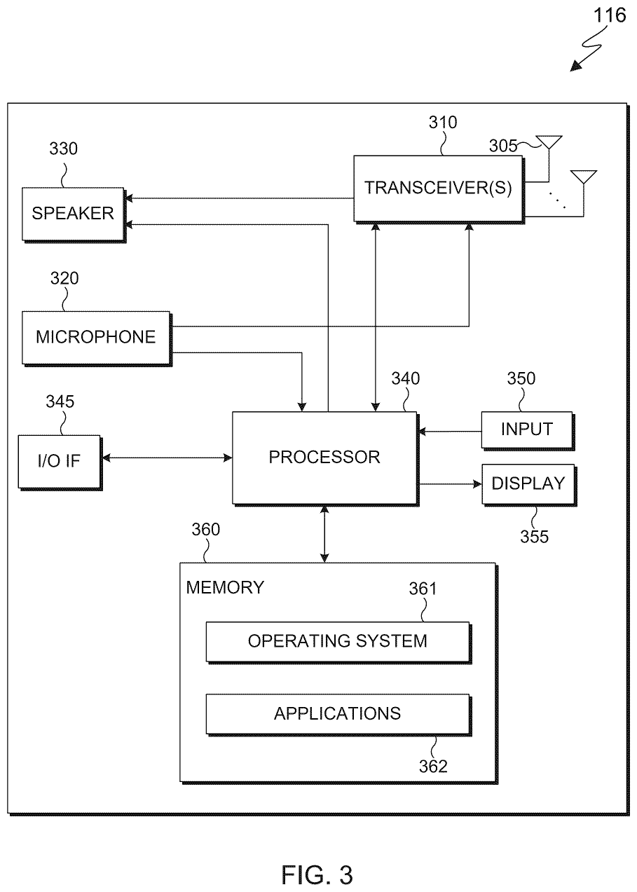

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing SIB1 repetition as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

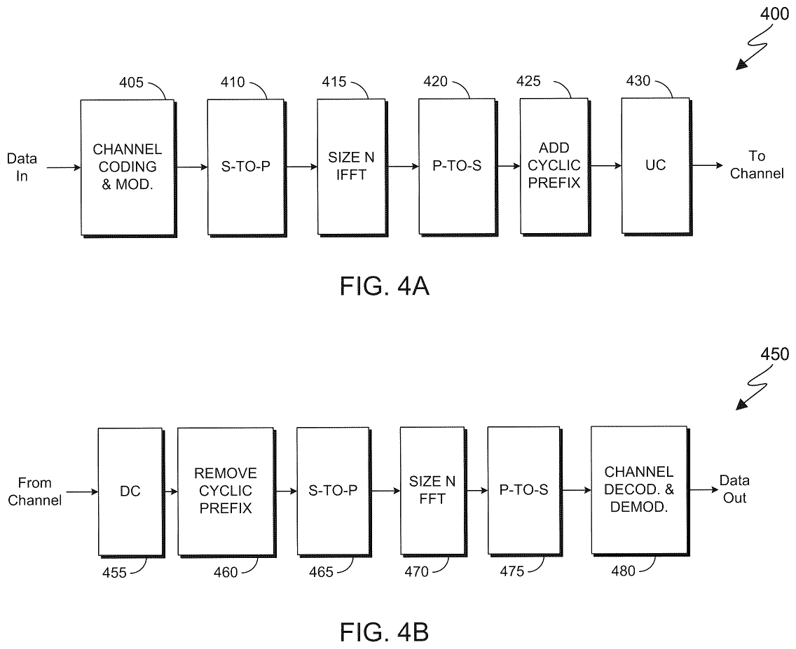

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for supporting SIB1 repetition as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the gNBs 101-103 and may implement a receive path 450 for receiving in the downlink from the gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In typical NR, SIB1 can be periodically transmitted by a gNB (such as gNB 102), and a UE (such as UE 116) monitors a physical downlink control channel (PDCCH) for scheduling the physical downlink shared channel (PDSCH) that carries the SIB1 with a periodicity of 20 ms, for synchronization signal/physical broadcast channel (SS/PBCH) block and CORESET #0 multiplexing Pattern 1, over 2 consecutive slots n₀ and n₀+1, when the subcarrier spacing (SCS) of the CORESET #0 is 15 kHz or 30 kHz. n₀ can be determined based on parameters O and M, wherein the parameters O and M are provided by master information block (MIB) (e.g., searchSpaceZero in pdcch-ConfigSIB1), and

$${n}_{0} = ( 0 \cdot {2}^{μ} + ⌊ i \cdot M ⌋ ) mod {N}_{slot}^{frame , μ}$$

for SS/PBCH block with index i, and

$${N}_{slot}^{frame , μ}$$

is the number of slots in a frame for SCS corresponding to μ. The system frame number (SFN) (e.g., SFN₀) for the slot n₀ satisfying

$${SFN}_{0} mod 2 = ⌊ ( O \cdot {2}^{μ} + ⌊ i \cdot M ⌋ ) / {N}_{slot}^{frame , μ} ⌋ mod 2 .$$

For one use case, the coverage of SIB1 may be limited when compared to another signal or channel, such as non-terrestrial-network (NTN), and PDCCH and/or PDSCH of SIB1 may need to be repeated such that a UE (such as UE 116) can combine the repeated transmission of SIB1 within the monitoring periodicity (e.g., 20 ms) to enhance the coverage of SIB1. Accordingly, the present disclosure includes a detailed design of repetition for PDCCH and/or PDSCH of SIB1.

For one consideration of this disclosure, the various embodiments and examples can be applicable when the SS/PBCH block and CORESET #0 are multiplexed in a first pattern (e.g., Pattern 1), wherein the SS/PBCH block and CORESET #0 do not occur at the same time instance and overlap in the frequency domain.

For another consideration of this disclosure, the various embodiments and examples can be applicable for bands in frequency range 1 (FR1) and/or for NTN.

In the present disclosure, a burst level repetition for the PDCCH and/or PDSCH of SIB1 is provided.

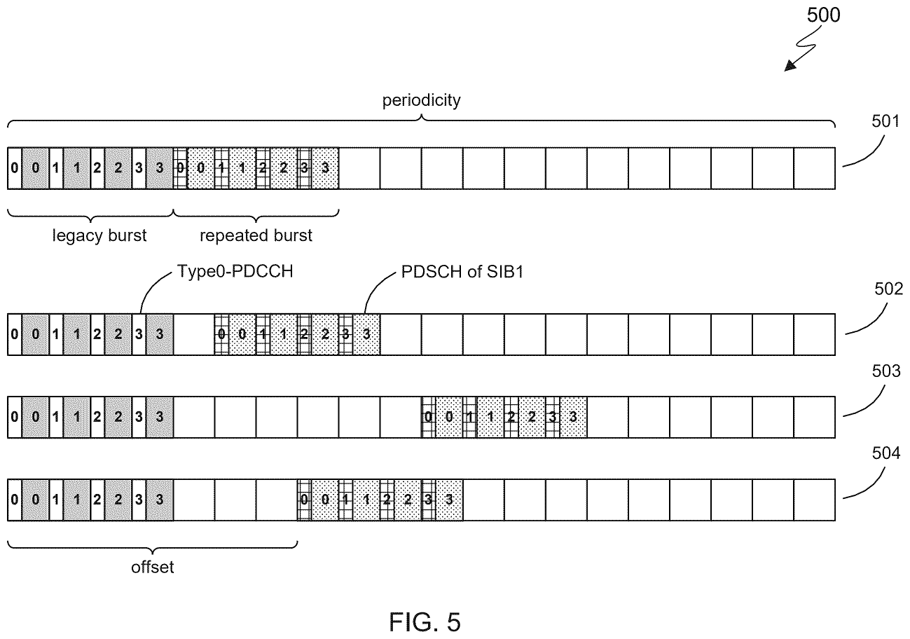

FIGS. 5-7 illustrate example repetition patterns 500, 600, and 700 of SIB1, respectively, that each relate to burst level repetition according to embodiments of the present disclosure. For example, repetition patterns 500, 600, and 700 of SIB1 can be implemented by the gNB 102 of FIG. 1. This example is for illustration only and other embodiments can be used without departing from the scope of the present disclosure.

In one embodiment, a burst of SIB1 transmission, including at least one of a PDCCH and/or a PDSCH of the SIB1, can be repeated within a periodicity.

For one example, the UE monitors Type0-PDCCH based on a first value of n₀ and a second value of n₁.
For one sub-example, for a SS/PBCH block with index i, the UE monitors Type0-PDCCH in two slots with indexes n₀ and n₁, respectively. For one further consideration, the UE assumes the contents of downlink control information (DCI) formats (e.g., including the scheduling information for the PDSCH) in the PDCCHs received in slot n₀ and n₁ are the same. For another further consideration, the UE assumes the SIB1 contents carried by the PDSCHs received in slot n₀ and n₁ are the same. For yet another further consideration, the UE may expect a transmission of PDCCH and/or PDSCH of SIB1 in both slots with indexes n₀ and n₁.
For another sub-example, for a SS/PBCH block with index i, the UE monitors Type0-PDCCH in two groups of consecutive slots, wherein the first group of consecutive slots are given by indexes of n₀ and n₀+1, and the second group of consecutive slots are given by indexes of n₁ and n₁+1. For one further consideration, the UE assumes the contents of DCI formats (e.g., including the scheduling information for the PDSCH) in the PDCCHs received in the two groups of slots are the same. For another further consideration, the UE assumes the SIB1 contents carried by the PDSCHs received in the two groups of slots are the same. For yet another further consideration, the UE may expect a transmission of PDCCH and/or PDSCH of SIB1 in both groups of slots.
For one sub-example, the value of n₁ can depend on the value of n₀, e.g.,

$${n}_{1} = {n}_{0} + {N}_{S S B}^{max} \cdot M + {N}_{slot}^{offset} , or$$

$${n}_{1} = ( {n}_{0} + {N}_{S S B}^{max} \cdot M + {N}_{slot}^{offset} ) mod {N}_{slot}^{frame , μ} , or$$

$${n}_{1} = ( O \cdot {2}^{μ} + ⌊ i \cdot M ⌋ + {N}_{S S B}^{max} \cdot M + {N}_{slot}^{offset} ) mod {N}_{slot}^{frame , μ} ,$$

wherein

$${N}_{SSB}^{max}$$

is the maximum number of candidate SS/PBCH blocks in a burst

$$( e . g . , {N}_{S S B}^{max} = 4 for FR 1 - NTN ) ,$$

M and/or O is the parameter for calculating n₀ and indicated by a field in MIB,

$${N}_{slot}^{frame , μ}$$

is a number of slots in a frame with respect to SCS corresponding to μ, and

$${N}_{slot}^{offset}$$

is a slot offset.
   For one instance,

$${N}_{slot}^{offset}$$

can be fixed as 0, as shown in 501 of FIG. 5. In this example, the burst of repeated SIB1 occurs immediately after the burst of legacy SIB1.
For another instance,

$${N}_{slot}^{offset}$$

can be fixed as 5·2^{μ} (wherein μ is the parameter corresponding to the SCS), as shown in 502 of FIG. 5. In this example, the burst of repeated SIB1 occurs in the next half frame after the burst of legacy SIB1.
For yet another instance,

$${N}_{slot}^{offset}$$

can be fixed as 10·2^{μ} (wherein μ is the parameter corresponding to the SCS), as shown in 503 of FIG. 5. In this example, the burst of repeated SIB1 occurs in the next frame after the burst of legacy SIB1.
For yet another instance,

$${N}_{slot}^{offset}$$

can be configurable (e.g., as one of the instances of this sub-example), as shown in 504 of FIG. 5, e.g., by the MIB or PBCH payload of the SS/PBCH block, or higher layer parameter from another cell.
For one sub-example, the SFN (e.g., SFN₁) for the slot n₁ satisfying

$${SFN}_{1} mod 2 = ⌊ ( O \cdot {2}^{μ} + ⌊ i \cdot M ⌋ + {N}_{S S B}^{max} \cdot M + {N}_{slot}^{offset} ) / {N}_{slot}^{frame , μ} ⌋ mod 2 , or$$

$${SFN}_{1} mod 2 = ⌊ ( {n}_{0} + {N}_{S S B}^{max} \cdot M + {N}_{slot}^{offset} ) / {N}_{slot}^{frame , μ} ⌋ mod 2 .$$

For one sub-example, this sub-example can be applicable at least for one from M=1, and/or M=½, and/or M=2.

For another example, the UE monitors Type0-PDCCH based on a first value of n₀, and receives PDSCH carrying SIB1 based on the first value of n₀ and a second value of n₁.
For one sub-example, for a SS/PBCH block with index i, the UE monitors Type0-PDCCH in a slot with index n₀, and a first PDSCH associated with the Type0-PDCCH is the same slot as the received Type0-PDCCH and the second PDSCH associated with the Type-PDCCH is in a slot with index n₁. For one further consideration, the UE assumes the SIB1 contents carried by the PDSCHs received in slot n₀ and n₁ are the same. For another further consideration, the UE may expect a transmission of PDSCH of SIB1 in both slots with indexes n₀ and n₁.
For another sub-example, for a SS/PBCH block with index i, the UE monitors Type0-PDCCH in two consecutive slots given by indexes of n₀ and n₀+1, and a first PDSCH associated with the Type0-PDCCH is the same slot as the received Type0-PDCCH and the second PDSCH associated with the Type-PDCCH is in a slot with index n₁. For one further consideration, the UE assumes the SIB1 contents carried by the two PDSCHs are the same. For yet another further consideration, the UE may expect a transmission of PDSCH of SIB1 in both slots with indexes n₀ (or n₀+1) and n₁.
For yet another sub-example, for a SS/PBCH block with index i, the UE monitors Type0-PDCCH in two consecutive slots given by indexes of n₀ and n₀+1, and a first PDSCH associated with the Type0-PDCCH is the same slot as the received Type0-PDCCH and the second PDSCH associated with the Type-PDCCH is in a slot with index n₁ or n₁+1. For one further consideration, the UE assumes the SIB1 contents carried by the two PDSCHs are the same. For another further consideration, if the first PDSCH is received in slot n₀, then the second PDSCH is received in slot n₁. For yet another further consideration, if the first PDSCH is received in slot n₀+1, then the second PDSCH is received in slot n₁+1. For yet another further consideration, the UE may expect a transmission of PDSCH of SIB1 in both slots with indexes n₀ (or n₀+1) and n₁ (or n₁+1).
For one sub-example, the value of n₁ can depend on the value of n₀, e.g.,

$${n}_{1} = {n}_{0} + {N}_{S S B}^{max} \cdot M + {N}_{slot}^{offset} , or$$

$${n}_{1} = ( {n}_{0} + {N}_{S S B}^{max} \cdot M + {N}_{slot}^{offset} ) mod {N}_{slot}^{frame , μ} , or$$

$${n}_{1} = ( O \cdot {2}^{μ} + ⌊ i \cdot M ⌋ + {N}_{S S B}^{max} \cdot M + {N}_{slot}^{offset} ) mod {N}_{slot}^{frame , μ} ,$$

wherein

$${N}_{S S B}^{max}$$

is the maximum number of candidate SS/PBCH blocks in a burst

$$( e . g . , {N}_{S S B}^{max} = 4 for FR 1 - NTN ) ,$$

M and/or O is the parameter for calculating n₀ and indicated by a field in MIB,

$${N}_{slot}^{frame , μ}$$

is a number of slots in a frame with respect to SCS corresponding to μ, and

$${N}_{slot}^{offset}$$

is a slot offset.
   For one instance,

$${N}_{slot}^{offset}$$

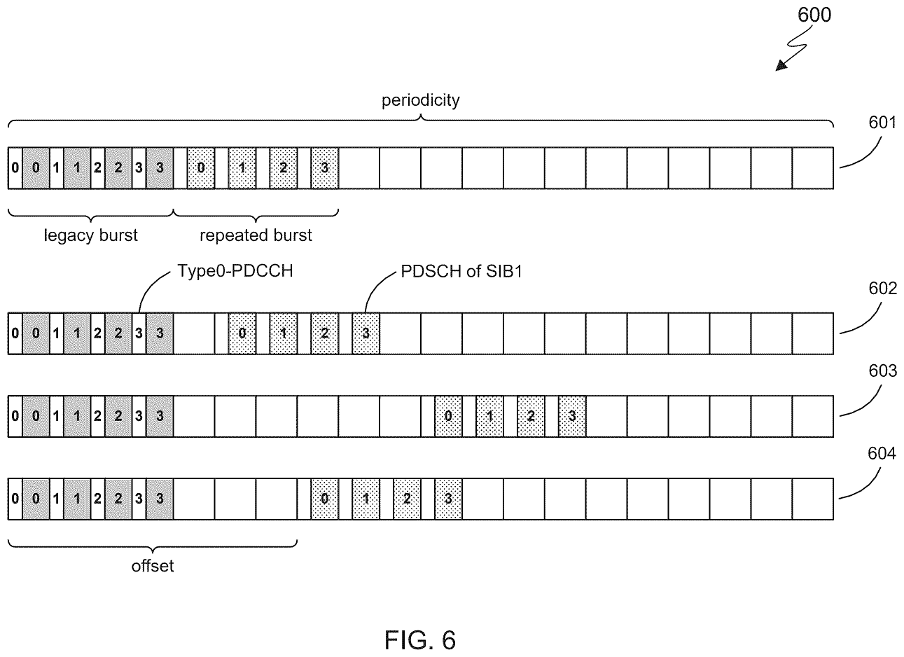

can be fixed as 0, as shown in 601 of FIG. 6. In this example, the burst of repeated SIB1 occurs immediately after the burst of legacy SIB1.
For another instance,

$${N}_{slot}^{offset}$$

can be fixed as 5·2^{μ} (wherein μ is the parameter corresponding to the SCS), as shown in 602 of FIG. 6. In this example, the burst of repeated SIB1 occurs in the next half frame after the burst of legacy SIB1.
For yet another instance,

$${N}_{slot}^{offset}$$

can be fixed as 10·2^{μ} (wherein μ is the parameter corresponding to the SCS), as shown in 603 of FIG. 6. In this example, the burst of repeated SIB1 occurs in the next frame after the burst of legacy SIB1.
For yet another instance,

$${N}_{slot}^{offset}$$

can be configurable (e.g., as one of the instances of this sub-example), as shown in 604 of FIG. 6, e.g., by the MIB or PBCH payload of the SS/PBCH block, or higher layer parameter from another cell.
For one sub-example, the SFN (e.g., SFN₁) for the slot n₁ satisfying

$${SFN}_{1} mod 2 = ⌊ ( O \cdot {2}^{μ} + ⌊ i \cdot M ⌋ + {N}_{SSB}^{max} \cdot M + {N}_{slot}^{offset} ) / {N}_{slot}^{frame , μ} ⌋ mod 2 ,$$

$$or {SFN}_{1} mod 2 = ⌊ ( {n}_{0} + {N}_{SSB}^{max} \cdot M + {N}_{slot}^{offset} ) / {N}_{slot}^{frame , μ} ⌋ mod 2.$$

For one sub-example, this sub-example can be applicable at least for one from M=1, and/or M=½, and/or M=2.
For one sub-example, the UE can assume the scheduling information (e.g., time domain resource, and/or frequency domain resource) of the two PDSCHs is the same.

For yet another example, the UE monitors Type0-PDCCH based on a first value of n₀, and receives PDSCH carrying SIB1 based on the first value of n₀ and a second value of n₁.
For one sub-example, for a SS/PBCH block with index i, the UE monitors Type0-PDCCH in a slot with index n₀, and a first PDSCH associated with the Type0-PDCCH is the same slot as the received Type0-PDCCH and the second PDSCH associated with the Type-PDCCH is in a slot with index n₁. For one further consideration, the UE assumes the SIB1 contents carried by the PDSCHs received in slot n₀ and n₁ are the same. For another further consideration, the UE may expect a transmission of PDSCH of SIB1 in both slots with indexes n₀ and n₁.
For another sub-example, for a SS/PBCH block with index i, the UE monitors Type0-PDCCH in two consecutive slots given by indexes of n₀ and n₀+1, and a first PDSCH associated with the Type0-PDCCH is the same slot as the received Type0-PDCCH and the second PDSCH associated with the Type-PDCCH is in a slot with index n₁. For one further consideration, the UE assumes the SIB1 contents carried by the two PDSCHs are the same. For yet another further consideration, the UE may expect a transmission of PDSCH of SIB1 in both slots with indexes n₀ (or n₀+1) and n₁.
For yet another sub-example, for a SS/PBCH block with index i, the UE monitors Type0-PDCCH in two consecutive slots given by indexes of n₀ and n₀+1, and a first PDSCH associated with the Type0-PDCCH is the same slot as the received Type0-PDCCH and the second PDSCH associated with the Type-PDCCH is in a slot with index n₁ or n₁+1. For one further consideration, the UE assumes the SIB1 contents carried by the two PDSCHs are the same. For another further consideration, if the first PDSCH is received in slot n₀, then the second PDSCH is received in slot n₁. For yet another further consideration, if the first PDSCH is received in slot n₀+1, then the second PDSCH is received in slot n₁+1. For yet another further consideration, the UE may expect a transmission of PDSCH of SIB1 in both slots with indexes n₀ (or n₀+1) and n₁ (or n₁+1).
For one sub-example, the value of n₁ can depend on the value of n₀, e.g.,

$${n}_{1} = {n}_{0} + {N}_{SSB}^{max} \cdot M + {N}_{slot}^{offset} , or {n}_{1} = ( {n}_{0} + {N}_{SSB}^{max} \cdot M + {N}_{slot}^{offset} ) mod {N}_{slot}^{frame , μ} ,$$

$$or {n}_{1} = ( O \cdot {2}^{μ} + ⌊ i \cdot M ⌋ + {N}_{SSB}^{max} \cdot M + {N}_{slot}^{offset} ) mod {N}_{slot}^{frame , μ} ,$$

wherein

$${N}_{SSB}^{max}$$

is the maximum number of candidate SS/PBCH blocks in a burst

$$( e . g . , {N}_{SSB}^{max} = 4 for FR 1 - NTN ) ,$$

M and/or O is the parameter for calculating n₀ and indicated by a field in MIB,

$${N}_{slot}^{frame , μ}$$

is a number of slots in a frame with respect to SCS corresponding to μ, and

$${N}_{slot}^{offset}$$

is a slot offset.
   For one instance,

$${N}_{slot}^{offset}$$

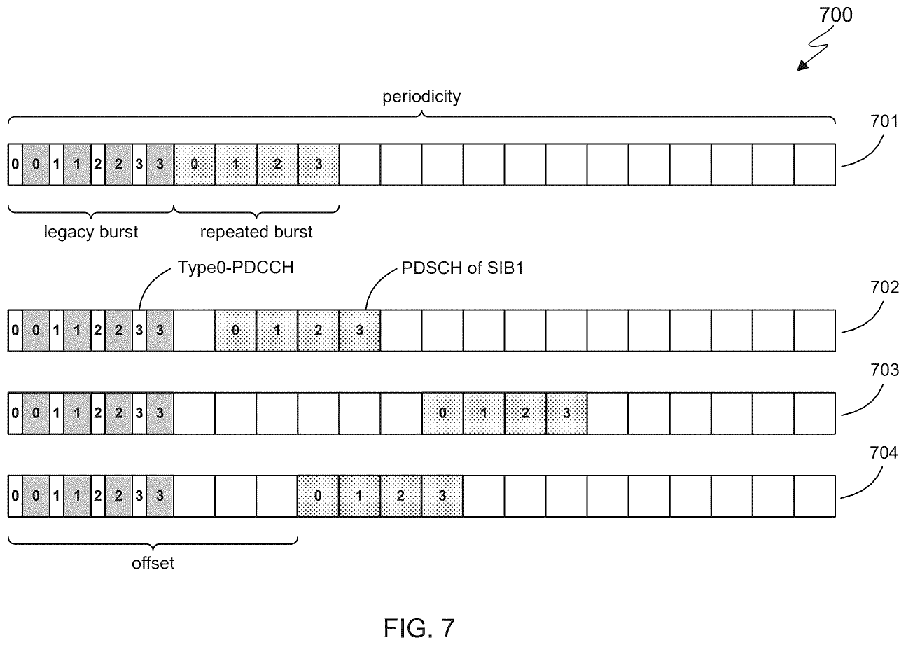

can be fixed as 0, as shown in 701 of FIG. 7. In this example, the burst of repeated SIB1 occurs immediately after the burst of legacy SIB1.
For another instance,

$${N}_{slot}^{offset}$$

can be fixed as 5·2^{μ} (wherein μ is the parameter corresponding to the SCS), as shown in 702 of FIG. 7. In this example, the burst of repeated SIB1 occurs in the next half frame after the burst of legacy SIB1.
For yet another instance,

$${N}_{slot}^{offset}$$

can be fixed as 10·2^{μ} (wherein μ is the parameter corresponding to the SCS), as shown in 703 of FIG. 7. In this example, the burst of repeated SIB1 occurs in the next frame after the burst of legacy SIB1.
For yet another instance,

$${N}_{slot}^{offset}$$

can be configurable (e.g., as one of the instances of this sub-example), as shown in 704 of FIG. 7, e.g., by the MIB or PBCH payload of the SS/PBCH block, or higher layer parameter from another cell.
For one sub-example, the SFN (e.g., SFN₁) for the slot n₁ satisfying

$${SFN}_{1} mod 2 = ⌊ ( O \cdot {2}^{μ} + ⌊ i \cdot M ⌋ + {N}_{SSB}^{max} \cdot M + {N}_{slot}^{offset} ) / {N}_{slot}^{frame , μ} ⌋ mod 2 ,$$

$$or {SFN}_{1} mod 2 = ⌊ ( {n}_{0} + {N}_{SSB}^{max} \cdot M + {N}_{slot}^{offset} ) / {N}_{slot}^{frame , μ} ⌋ mod 2.$$

For one sub-example, this sub-example can be applicable at least for one from M=1, and/or M=½, and/or M=2.
For one sub-example, the UE can assume the scheduling information (e.g., time domain resource, and/or frequency domain resource) of the first PDSCHs is a subset of the one of the second PDSCH, e.g., the second PDSCH also includes the time domain resource, and/or frequency domain resource for the Type0-PDCCH in the slot.

In the present disclosure, a block level repetition for the PDCCH and/or PDSCH of SIB1 is provided.

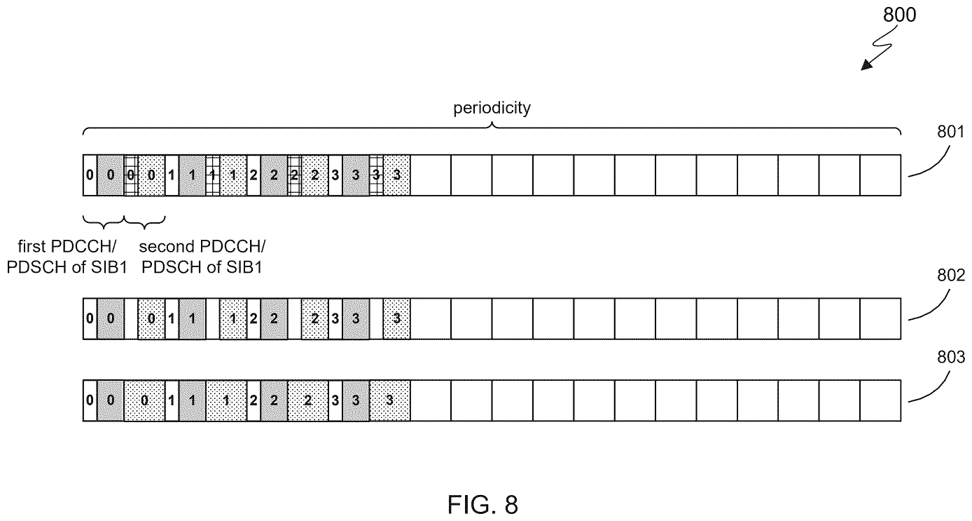

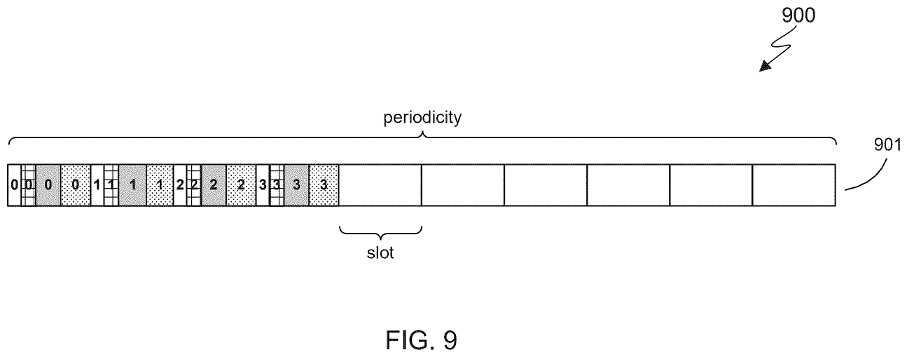

FIGS. 8 and 9 illustrate example repetition patterns 800 and 900 of SIB1, respectively, that each relate to block level repetition according to embodiments of the present disclosure. For example, repetition patterns 800 and 900 of SIB1 can be implemented by the gNB 102 of FIG. 1. This example is for illustration only and other embodiments can be used without departing from the scope of the present disclosure.

In one embodiment, PDCCH and/or PDSCH of the SIB1 can be repeated within a periodicity.

For one example, as shown in 801 of FIG. 8, the UE monitors Type0-PDCCH based on a first value of n₀.
For one sub-example, for a SS/PBCH block with index i, the UE monitors Type0-PDCCH in two consecutive slots with indexes n₀ and n₀+1. For one further consideration, a first PDSCH associated with the Type0-PDCCH is in slot with index n₀. For another further consideration, a second PDSCH associated with the Type0-PDCCH is in slot with index n₀+1. For yet another further consideration, the UE assumes the SIB1 contents carried by the PDSCHs received in slot n₀ and n₀+1 are the same. For yet another further consideration, the UE may expect a transmission of PDSCH of SIB1 in both slots with indexes n₀ and n₀+1. For yet another further consideration, the UE assumes the contents of DCI formats (e.g., including the scheduling information for the PDSCH) in the Type0-PDCCHs (e.g., the first Type0-PDCCH in slot with index n₀ and the second Type0-PDCCH in slot with index n₀+1) are the same.
For another sub-example, for a SS/PBCH block with index i, the UE monitors Type0-PDCCH in two groups of two consecutive slots, wherein the first group includes slots with indexes n₀ and n₀+1, and the second group includes slots with indexes n₀+1 and n₀+2. For one further consideration, a first PDSCH associated with the Type0-PDCCH is in the first group. For another further consideration, a second PDSCH associated with the Type0-PDCCH is in the second group. For yet another further consideration, the UE assumes the SIB1 contents carried by the two PDSCHs received are the same. For yet another further consideration, the UE may expect a transmission of PDSCH of SIB1 in both slots with indexes n₀ and n₀+1. For yet another further consideration, the UE assumes the contents of DCI formats (e.g., including the scheduling information for the PDSCH) in the Type0-PDCCHs are the same. For yet another further consideration, the UE may expect the two Type0-PDCCHs are received in two consecutive slots.
For one sub-example, the value of n₀ can be determined as

$${n}_{0} = ( O \cdot {2}^{μ} + 2 \cdot ⌊ i \cdot M ⌋ ) mod {N}_{slot}^{frame , μ} , or {n}_{0} = ( O \cdot {2}^{μ} + 2 \cdot i ) mod {N}_{slot}^{frame , μ} ,$$

wherein M and/or O is the parameter for calculating n₀ and indicated by a field in MIB, and

$${N}_{slot}^{frame , μ}$$

is a number of slots in a frame with respect to SCS corresponding to μ.
For one sub-example, the SFN (e.g., SFN₀) for the slot n₀ satisfying

$${SFN}_{0} mod 2 = ⌊ ( O \cdot {2}^{μ} + 2 \cdot ⌊ i \cdot M ⌋ ) / {N}_{slot}^{frame , μ} ⌋ mod 2 , or$$

$${SFN}_{0} mod 2 = ⌊ ( O \cdot {2}^{μ} + 2 \cdot i ) / {N}_{slot}^{frame , μ} ⌋ mod 2.$$

For one sub-example, this sub-example can be applicable at least for one from M=1, and/or M=½, and/or M=2.

For another example, as shown in 802 of FIG. 8, the UE monitors Type0-PDCCH based on a first value of n₀.
For one sub-example, for a SS/PBCH block with index i, the UE monitors Type0-PDCCH in slot with index n₀. For one further consideration, a first PDSCH associated with the Type0-PDCCH is in slot with index n₀. For another further consideration, a second PDSCH associated with the Type0-PDCCH is in slot with index n₀+1. For yet another further consideration, the UE assumes the SIB1 contents carried by the PDSCHs received in slot n₀ and n₀+1 are the same. For yet another further consideration, the UE may expect a transmission of PDSCH of SIB1 in both slots with indexes n₀ and n₀+1.
For another sub-example, for a SS/PBCH block with index i, the UE monitors Type0-PDCCH in two consecutive slots with indexes n₀ and n₀+1. For one further consideration, a first PDSCH associated with the Type0-PDCCH is in the slot n₀. For another further consideration, a second PDSCH associated with the Type0-PDCCH is in the slot n₀+1. For yet another further consideration, the UE assumes the SIB1 contents carried by the two PDSCHs received are the same. For yet another further consideration, the UE may expect a transmission of PDSCH of SIB1 in both slots with indexes no and n₀+1.
For one sub-example, the value of n₀ can be determined as

$${n}_{0} = ( O \cdot {2}^{μ} + 2 \cdot ⌊ i \cdot M ⌋ ) mod {N}_{slot}^{frame , μ} , or {n}_{0} = ( O \cdot {2}^{μ} + 2 \cdot i ) mod {N}_{slot}^{frame , μ} ,$$

wherein M and/or O is the parameter for calculating n₀ and indicated by a field in MIB, and

$${N}_{slot}^{frame , μ}$$

is a number of slots in a frame with respect to SCS corresponding to μ.
For one sub-example, the SFN (e.g., SFN₀) for the slot n₀ satisfying

$${SFN}_{0} mod 2 = ⌊ ( O \cdot {2}^{μ} + 2 \cdot ⌊ i \cdot M ⌋ ) / {N}_{slot}^{frame , μ} ⌋ mod 2 , or$$

$${SFN}_{0} mod 2 = ⌊ ( O \cdot {2}^{μ} + 2 \cdot i ) / {N}_{slot}^{frame , μ} ⌋ mod 2.$$

For one sub-example, this sub-example can be applicable at least for one from M=1, and/or M=½, and/or M=2.
For one sub-example, the UE can assume the scheduling information (e.g., time domain resource, and/or frequency domain resource) of the two PDSCHs is the same.

For yet another example, as shown in 803 of FIG. 8, the UE monitors Type0-PDCCH based on a first value of n₀.
For one sub-example, for a SS/PBCH block with index i, the UE monitors Type0-PDCCH in slot with index n₀. For one further consideration, a first PDSCH associated with the Type0-PDCCH is in slot with index n₀. For another further consideration, a second PDSCH associated with the Type0-PDCCH is in slot with index n₀+1. For yet another further consideration, the UE assumes the SIB1 contents carried by the PDSCHs received in slot n₀ and n₀+1 are the same. For yet another further consideration, the UE may expect a transmission of PDSCH of SIB1 in both slots with indexes n₀ and n₀+1.
For another sub-example, for a SS/PBCH block with index i, the UE monitors Type0-PDCCH in two consecutive slots with indexes n₀ and n₀+1. For one further consideration, a first PDSCH associated with the Type0-PDCCH is in the slot n₀. For another further consideration, a second PDSCH associated with the Type0-PDCCH is in the slot n₀+1. For yet another further consideration, the UE assumes the SIB1 contents carried by the two PDSCHs received are the same. For yet another further consideration, the UE may expect a transmission of PDSCH of SIB1 in both slots with indexes n₀ and n₀+1.
For one sub-example, the value of n₀ can be determined as

$${n}_{0} = ( O \cdot {2}^{μ} + 2 \cdot ⌊ i \cdot M ⌋ ) mod {N}_{slot}^{frame , μ} , or {n}_{0} = ( O \cdot {2}^{μ} + 2 \cdot i ) mod {N}_{slot}^{frame , μ} ,$$

wherein M and/or O is the parameter for calculating n₀ and indicated by a field in MIB, and

$${N}_{slot}^{frame , μ}$$

is a number of slots in a frame with respect to SCS corresponding to μ.
For one sub-example, the SFN (e.g., SFN₀) for the slot n₀ satisfying

$${SFN}_{0} mod 2 = ⌊ ( O \cdot {2}^{μ} + 2 \cdot ⌊ i \cdot M ⌋ ) / {N}_{slot}^{frame , μ} ⌋ mod 2 , or$$

$${SFN}_{0} mod 2 = ⌊ ( O \cdot {2}^{μ} + 2 \cdot i ) / {N}_{slot}^{frame , μ} ⌋ mod 2.$$

For one sub-example, this sub-example can be applicable at least for one from M=1, and/or M=½, and/or M=2.
For one sub-example, the UE can assume the scheduling information (e.g., time domain resource, and/or frequency domain resource) of the first PDSCHs is a subset of the one of the second PDSCH, e.g., the second PDSCH also includes the time domain resource, and/or frequency domain resource for the Type0-PDCCH in the slot.

For yet another example, as shown in 901 of FIG. 9, the UE monitors Type0-PDCCH based on a first value of n₀.
For one sub-example, for a SS/PBCH block with index i, the UE monitors two Type0-PDCCHs in slot with index n₀, e.g., one starting from symbol 0 and the other starring from symbol

$${N}_{symb}^{CORESET} ,$$

wherein

$${N}_{symb}^{CORESET}$$

is a number of symbols in the CORESET. For one further consideration, a first PDSCH associated with the Type0-PDCCH is in slot with index n₀. For another further consideration, a second PDSCH associated with the Type0-PDCCH is in slot with index n₀. For yet another further consideration, the UE assumes the SIB1 contents carried by the two PDSCHs are the same. For yet another further consideration, the UE may expect the two PDSCHs of SIB1 are both transmitted. For yet another further consideration, the UE assumes the contents of DCI formats (e.g., including the scheduling information for the PDSCH) in the Type0-PDCCHs are the same.
For one sub-example, for a SS/PBCH block with index i, the UE monitors two Type0-PDCCHs in slot with index n₀ or slot with index n₀+1, e.g., one starting from symbol 0 and the other starring from symbol

$${N}_{symb}^{CORESET} ,$$

wherein

$${N}_{symb}^{CORESET}$$

is a number of symbols in the CORESET. For one further consideration, a first PDSCH associated with the Type0-PDCCH is in the slot where the first Type0-PDCCH is received. For another further consideration, a second PDSCH associated with the Type0-PDCCH is in the slot where the second Type0-PDCCH is received. For yet another further consideration, the UE assumes the SIB1 contents carried by the two PDSCHs are the same. For yet another further consideration, the UE may expect the two PDSCHs of SIB1 are both transmitted. For yet another further consideration, the UE assumes the contents of DCI formats (e.g., including the scheduling information for the PDSCH) in the Type0-PDCCHs are the same. For yet another further consideration, the UE expects the two Type0-PDCCHs are received in the same slot.
For one sub-example, the value of n₀ can be determined as

$${n}_{0} = ( O \cdot {2}^{μ} + ⌊ i \cdot M \cdot 2 ⌋ ) mod {N}_{slot}^{frame , μ} , or {n}_{0} = ( O \cdot {2}^{μ} + i ) mod {N}_{slot}^{frame , μ} ,$$

wherein M and/or O is the parameter for calculating n₀ and indicated by a field in MIB, and

$${N}_{slot}^{frame , μ}$$

is a number of slots in a frame with respect to SCS corresponding to μ.
For one sub-example, the SFN (e.g., SFN₀) for the slot n₀ satisfying

$${SFN}_{0} mod 2 = ⌊ ( O \cdot {2}^{μ} + ⌊ i \cdot M ⌋ ) / {N}_{slot}^{frame , μ} ⌋ mod 2 , or$$

$${SFN}_{0} mod 2 = ⌊ ( O \cdot {2}^{μ} + i ) / {N}_{slot}^{frame , μ} ⌋ mod 2.$$

For one sub-example, this sub-example can be applicable at least for M=½.

In the present disclosure, indication of the repetition is provided.

In one embodiment, an indication of the repetition and/or the repetition pattern can be provided to a UE.

For one example, there can be an indication on whether repetition is applied for PDCCH and/PDSCH of SIB1.

For one sub-example, the indication can be carried by the frequency location of SS/PBCH block. For instance, when the frequency location of the SS/PBCH block corresponds to a different set of synchronization raster entries (from the legacy set of synchronization raster entries where the PDCCH and/PDSCH of SIB1 is not repeated), the UE can assume the SS/PBCH block is associated with repeated PDCCH and/PDSCH of SIB1.

For another sub-example, the indication can be carried by a primary synchronization signal (PSS) sequence. For instance, when the UE receives a PSS based on a sequence from a different set of sequences than the legacy set of PSS sequences, the UE can assume the SS/PBCH block is associated with repeated PDCCH and/PDSCH of SIB1.

For yet another sub-example, the indication can be carried by a secondary synchronization signal (SSS) sequence. For instance, when the UE receives a SSS based on a sequence from a different set of sequences than the legacy set of SSS sequences, the UE can assume the SS/PBCH block is associated with repeated PDCCH and/PDSCH of SIB1.

For yet another sub-example, the indication can be carried by a demodulation reference signal (DM-RS) sequence of PBCH. For instance, when the UE receives a DM-RS sequence of PBCH based on a sequence from a different set of sequences than the legacy set of DM-RS sequences of PBCH, the UE can assume the SS/PBCH block is associated with repeated PDCCH and/or PDSCH of SIB1.

For yet another sub-example, the indication can be carried by a bit or a field in a payload of PBCH.
For one instance, one bit from MIB can be used for the indication of whether the SS/PBCH block is associated with repeated PDCCH and/PDSCH of SIB1.
For another instance, one bit from MIB can be reinterpreted for the indication of whether the SS/PBCH block is associated with repeated PDCCH and/PDSCH of SIB1, e.g., the one bit can be at least one from systemFrameNumber, subCarrierSpacingCommon, ssb-SubcarrierOffset, pdcch-ConfigSIB1, or spare.
For yet another instance, one bit from PHY layer and in the PBCH payload (e.g., the at least one bit is not included in MIB but in PBCH payload) can be used for the indication of whether the SS/PBCH block is associated with repeated PDCCH and/or PDSCH of SIB1, e.g., one bit from ā_{Ā}, ā_{Ā+1}, ā_{Ā+2}, ā_{Ā+3}, ā_{Ā+4}, ā_{Ā+5}, ā_{Ā+6}, ā_{Ā+7}.

For yet another sub-example, the indication can be carried by a bit or a field in a DCI format carried by the Type0-PDCCH (e.g., DCI format 1_0).
For one instance, one reserved bit can be used to indicate whether PDCCH and/PDSCH of SIB1 is repeated.
For another instance, at least one bit in the reserved bits can be used to indicate the index of the prepetition (e.g., for the associated PDCCH and/or PDSCH) within the repeated PDCCHs and/or PDSCHs of SIB1.

For another example, there can be an indication on a pattern the repetition, e.g., including at least one of a number of repetitions, or an example of the repetitions in the disclosure when multiple examples are supported.

For yet another sub-example, the indication can be carried by bit(s) or a field in a payload of PBCH.
For one instance, at least one bit from MIB can be used for the indication on a pattern the repetition, e.g., the at least one bit can be at least one from systemFrameNumber, subCarrierSpacingCommon, ssb-SubcarrierOffset, pdcch-ConfigSIB1, or spare.
For yet another instance, at least one bit from PHY layer and in the PBCH payload (e.g., the at least one bit is not included in MIB but in PBCH payload) can be used for the indication on a pattern the repetition, e.g., one bit from ā_{Ā}, ā_{Ā+1}, ā_{Ā+2}, ā_{Ā+3}, ā_{Ā+4}, ā_{Ā+5}, ā_{Ā+6}, ā_{Ā+7}.

For yet another sub-example, the indication can be carried by bit(s) or a field in a DCI format carried by the Type0-PDCCH (e.g., DCI format 1_0).
For one instance, at least one reserved bit can be used for the indication on a pattern the repetition.

In the present disclosure, scrambling and interleaving for the repeated PDCCH and/or PDSCH of SIB1 is provided.

In one embodiment, the scrambling sequence and/or an interleaving for the repeated PDCCH and/or repeated PDSCH of the SIB1 can be different.

For one example, the interleaving in control channel element to resource element group (CCE-to-REG) mapping for Type0-PDCCH can be based on an index of the repetition within the repetitions, or based on an index of the slot including the Type0-PDCCH.

For another example, the scrambling sequence for Type0-PDCCH can be based on an index of the repetition within the repetitions, or based on an index of the slot including the Type0-PDCCH.

For yet another example, the scrambling sequence for PDSCH of SIB1 can be based on an index of the repetition within the repetitions, or based on an index of the slot including the PDSCH.

In the present disclosure, an example UE procedure for receiving the repeated PDCCH and/or PDSCH of SIB1 is provided.

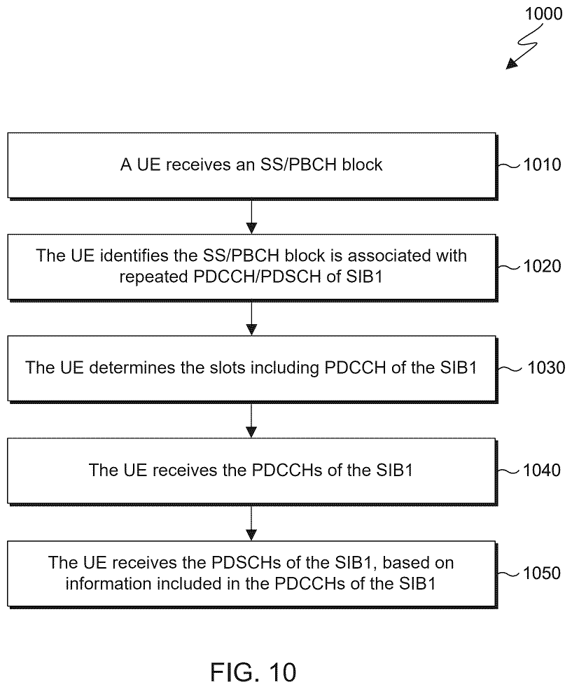

FIG. 10 illustrates an example method 1000 performed by a UE in a wireless communication system according to embodiments of the present disclosure. The method 1000 of FIG. 10 can be performed by any of the UEs 111-116 of FIG. 1, such as the UE 116 of FIG. 3, and a corresponding method can be performed by any of the gNBs 101-103 of FIG. 1, such as gNB 102 of FIG. 2. The method 1000 is for illustration only and other embodiments can be used without departing from the scope of the present disclosure.

The method 1000 begins with a UE receiving an SS/PBCH block (1010). The UE then identifies that the SS/PBCH block is associated with repeated PDCCH/PDSCH of SIB1 (1020). Next, the UE determines the slots that include PDCCH of the SIB1 (1030). Next, the UE receives the PDCCHs of the SIB1 (1040). Finally, the method 1000 ends with the UE receiving the PDSCHs of the SIB1 based on information included in the PDCCHs of the SIB1 (1050).

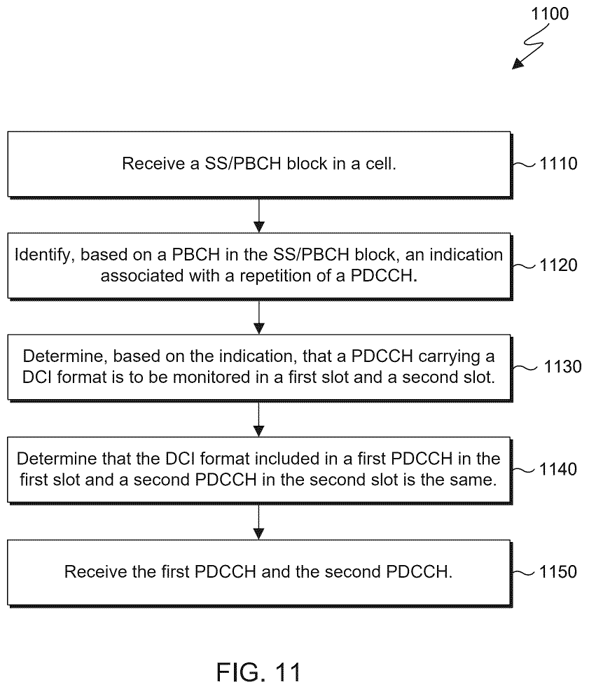

FIG. 11 illustrates another example method 1100 performed by a UE in a wireless communication system according to embodiments of the present disclosure. The method 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

The method 1100 begins with the UE receiving a SS/PBCH block in a cell (1110). In various embodiments, the cell is in FR1. In various embodiments, the cell is for NTN. The UE then identifies, based on a PBCH in the SS/PBCH block, an indication associated with a repetition of a PDCCH (1120). In various embodiments, the indication is based on one bit ā_{Ā+7} in a payload of the PBCH.

The UE then determines, based on the indication, that a PDCCH carrying a DCI format is to be monitored in a first slot and a second slot (1130). In various embodiments, the PDCCH is a Type0-PDCCH for scheduling a PDSCH of a SIB1. The UE then determines that the DCI format included in a first PDCCH in the first slot and a second PDCCH in the second slot is the same (1140). The UE then receives the first PDCCH and the second PDCCH (1150).

In various embodiments, the first slot

$${n}_{0} = ( O \cdot {2}^{μ} + 2 \cdot ⌊ i \cdot M ⌋ ) mod {N}_{slot}^{frame , μ} ,$$

where M and O are parameters associated with a field in a payload of the PBCH, i is an index of the SS/PBCH block, μ is a subcarrier spacing of the PDCCH, and

$${N}_{slot}^{frame , μ}$$

is a number of slots in a frame with respect to the subcarrier spacing corresponding to μ. For example, a SFN₀ for the first slot n₀ satisfies

$${SFN}_{0} mod 2 = ⌊ \frac{O \cdot {2}^{μ} + 2 \cdot ⌊ i \cdot M ⌋}{{N}_{slot}^{frame , μ}} ⌋ mod 2.$$

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a synchronization signals and physical broadcast channel (SS/PBCH) block in a cell; and
a processor operably coupled to the transceiver, the processor configured to:
identify, based on a physical broadcast channel (PBCH) in the SS/PBCH block, an indication associated with a repetition of a physical downlink control channel (PDCCH);
determine, based on the indication, that a PDCCH carrying a downlink control information (DCI) format is to be monitored in a first slot (n₀) and a second slot (n₀+1); and
determine that the DCI format carried in a first PDCCH in the first slot and a second PDCCH in the second slot is the same,
wherein the transceiver is further configured to receive the first PDCCH and the second PDCCH.

2. The UE of claim 1, wherein the indication is based on one bit ā_{Ā+7} in a payload of the PBCH.

3. The UE of claim 1, wherein the PDCCH is a Type0-PDCCH for scheduling a physical downlink shared channel (PDSCH) of a system information block 1 (SIB1).

4. The UE of claim 1, wherein the cell is in frequency range 1 (FR1).

5. The UE of claim 1, wherein the cell is for non-terrestrial networks (NTN).

6. The UE of claim 1, wherein:
$${n}_{0} = ( O \cdot {2}^{μ} + 2 \cdot ⌊ i \cdot M ⌋ ) mod {N}_{slot}^{frame , μ} ,$$
where M and O are parameters associated with a field in a payload of the PBCH, i is an index of the SS/PBCH block, μ is a subcarrier spacing of the PDCCH, and
$${N}_{slot}^{frame , μ}$$
is a number of slots in a frame with respect to the subcarrier spacing corresponding to μ.

7. The UE of claim 6, wherein a system frame number (SFN₀) for the first slot n₀ satisfies
$${SFN}_{0} mod 2 = ⌊ \frac{O \cdot {2}^{μ} + 2 \cdot ⌊ i \cdot M ⌋}{{N}_{slot}^{frame , μ}} ⌋ mod 2.$$

8. A method of a user equipment (UE) in a wireless communication system, the method comprising:
receiving a synchronization signals and physical broadcast channel (SS/PBCH) block in a cell;
identifying, based on a physical broadcast channel (PBCH) in the SS/PBCH block, an indication associated with a repetition of a physical downlink control channel (PDCCH);
determining, based on the indication, that a PDCCH carrying a downlink control information (DCI) format is to be monitored in a first slot (n₀) and a second slot (n₀+1);
determining that the DCI format carried in a first PDCCH in the first slot and a second PDCCH in the second slot is the same; and
receiving the first PDCCH and the second PDCCH.

9. The method of claim 8, wherein the indication is based on one bit ā_{Ā+7} in a payload of the PBCH.

10. The method of claim 8, wherein the PDCCH is a Type0-PDCCH for scheduling a physical downlink shared channel (PDSCH) of a system information block 1 (SIB1).

11. The method of claim 8, wherein the cell is in frequency range 1 (FR1).

12. The method of claim 8, wherein the cell is for non-terrestrial networks (NTN).

13. The method of claim 8, wherein:
$${n}_{0} = ( O \cdot {2}^{μ} + 2 \cdot ⌊ i \cdot M ⌋ ) mod {N}_{slot}^{frame , μ} ,$$
where M and O are parameters associated with a field in a payload of the PBCH, i is an index of the SS/PBCH block, μ is a subcarrier spacing of the PDCCH, and
$${N}_{slot}^{frame , μ}$$
is a number of slots in a frame with respect to the subcarrier spacing corresponding to μ.

14. The method of claim 13, wherein a system frame number (SFN₀) for the first slot n₀ satisfies
$${SFN}_{0} mod 2 = ⌊ \frac{O \cdot {2}^{μ} + 2 \cdot ⌊ i \cdot M ⌋}{{N}_{slot}^{frame , μ}} ⌋ mod 2.$$

15. A base station (BS) in a wireless communication system, the BS comprising:
a processor configured to:
determine, based on a physical broadcast channel (PBCH) in a synchronization signals and physical broadcast channel (SS/PBCH) block in a cell, an indication associated with a repetition of a physical downlink control channel (PDCCH);
determine, based on the indication, that a PDCCH carrying a downlink control information (DCI) format is to be transmitted in a first slot (n₀) and a second slot (n₀+1); and
determine that the DCI format carried in a first PDCCH in the first slot and a second PDCCH in the second slot is the same; and
a transceiver operably coupled to the processor, the transceiver configured to:
transmit the SS/PBCH block; and
transmit the first PDCCH and the second PDCCH.

16. The BS of claim 15, wherein the indication is based on one bit ā_{Ā+7} in a payload of the PBCH.

17. The BS of claim 15, wherein the PDCCH is a Type0-PDCCH for scheduling a physical downlink shared channel (PDSCH) of a system information block 1 (SIB1).

18. The BS of claim 15, wherein the cell is in frequency range 1 (FR1).

19. The BS of claim 15, wherein the cell is for non-terrestrial networks (NTN).

20. The BS of claim 15, wherein:
$${n}_{0} = ( O \cdot {2}^{μ} + 2 \cdot ⌊ i \cdot M ⌋ ) mod {N}_{slot}^{frame , μ} ,$$
where M and O are parameters associated with a field in a payload of the PBCH, i is an index of the SS/PBCH block, μ is a subcarrier spacing of the PDCCH, and
$${N}_{slot}^{frame , μ}$$
is a number of slots in a frame with respect to the subcarrier spacing corresponding to μ; and
a system frame number (SFN₀) for the first slot n₀ satisfies
$${SFN}_{0} mod 2 = ⌊ \frac{O \cdot {2}^{μ} + 2 \cdot ⌊ i \cdot M ⌋}{{N}_{slot}^{frame , μ}} ⌋ mod 2.$$
